(19) United States
(12) Patent Application Publication
(10) Pub. No.: US 2026/0081887 A1
(43) Pub. Date: Mar. 19, 2026

(54) Computer System, Computer-Implemented Method, and Computer Readable Media for Synchronizing Chat Histories Used in Prompting Large Language Models (LLMS)

(71) Applicant: Shopify Inc., Ottawa (CA)

(72) Inventor: Ates GÖRAL, Toronto (CA)

(73) Assignee: Shopify Inc., Ottawa (CA)

(21) Appl. No.: 18/930,426

(22) Filed: Oct. 29, 2024

Related U.S. Application Data
(60) Provisional application No. 63/696,062, filed on Sep. 18, 2024.

(51) Int. Cl. H04L 51/216; H04L 51/02

(52) U.S. Cl. CPC H04L 51/216; G06F 40/166; G06F 40/35; H04L 51/02

(57) ABSTRACT

A system and method are provided for synchronizing chat histories used in prompting large language models (LLMs). The method includes receiving an indication of an interruption in a messaging conversation at a client application. The method also includes determining a last presented portion of a response. The response is generated by an LLM for the messaging conversation and provided to the client application in response to prompting the LLM with a prompt based on at least a first input provided to the client application. The method also includes modifying a chat history maintained by a server application based on the last presented portion of the response.

### CROSS-REFERENCE TO RELATED APPLICATIONS

This application claims priority to U.S. Provisional Application No. 63/696,062 filed on September 18, 2024, the entire contents of which are incorporated herein by reference.

### TECHNICAL FIELD

The following relates generally to prompting LLMs and, in particular, to synchronizing chat histories used in prompting such LLMs.

### BACKGROUND

LLMs are configured to respond to text inputs and typically generate an output until the LLM deems it has satisfactorily responded to the initial request. In some cases, users may wish to provide additional context that is relevant to the initial request.

### BRIEF DESCRIPTION OF THE DRAWINGS

Embodiments will now be described with reference to the appended drawings wherein:

FIG. 1 is an example of a computing environment in which an LLM is utilized by a server application in exchanging data and information with a client application.

FIG. 2 is an example of a configuration for utilizing an active listening module and chat history synchronizer to synchronize chat histories used in prompting an LLM.

FIG. 3 is a sequence diagram illustrating a chat history synchronization process.

FIG. 4 is an example of a computing device operable to communicate in the computing environment.

FIG. 5 is a flow chart illustrating example operations for modifying a chat history maintained by a server application based on a last presented portion of a response from an LLM.

FIG. 6 is a flow chart illustrating example operations for incorporating a second input into a chat history that is modified based on a last presented portion of a response from an LLM.

FIG. 7 is a flow chart illustrating example operations for utilizing an input from a client application to obtain a response from an LLM that is provided to the client application in multiple portions.

FIG. 8 is a flow chart illustrating example operations for detecting and reacting to an interruption in a messaging conversation.

FIG. 9 illustrates an animation being played in a messaging conversation user interface (UI).

FIG. 10 illustrates an interruption and resumption sequence responsive to a stop operation detected in a messaging conversation UI.

FIG. 11 illustrates an interruption and resumption sequence responsive to a follow-up message sent in a messaging conversation UI.

FIGS. 12a and 12b illustrate an interruption and resumption sequence responsive to detecting composition of a follow-up message sent in a messaging conversation UI.

FIG. 13 is a block diagram of a simplified convolutional neural network, which may be used in examples of the present disclosure.

FIG. 14 is a block diagram of a simplified transformer neural network, which may be used in examples of the present disclosure.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

A potential issue with additional context relevant to an initial request to an LLM (e.g., a subsequent input), is that the LLM may have already begun processing the initial request. For example, when the user interjects or interrupts the LLM response, the output provided to the user on the client side may be less than what the LLM has generated at the server side. Consequently, the standard back and forth of one complete user input to one complete computer response may be disrupted.

When the server side that uses an LLM becomes out of sync with what is presented to the user, the LLM may generate an output that is erroneous, irrelevant, or only partially answers the request. Since at least some of the initial response has been generated, subsequent requests from the user may cause the erroneous/irrelevant output to be included in the chat message history. This can both inflate token usage and lead to errors in subsequent responses generated by the LLM.

Moreover, it is recognized that in some cases, the LLM may have continued generating its response after the user has interrupted it, or there may be a delay between what a back end or server-side system has generated and what is displayed to the user. For example, in some examples, the user experience paradigm presents the LLM response to the user in a continuous stream of characters as opposed to presenting a large paragraph of text in a single rendering call as it is easy for the user to track and read as it is being streamed. In such a case, the server-side transcript and the front end or client-side UI or transcript, at the point when the user or system interrupted the response, may be out of sync.

The system described herein provides an active listening module that implements a mechanism to maintain synchronicity between the client-side UI (e.g., what has been presented to the user) and the server-side transcript or chat history (e.g., what the LLM has generated and believes has been passed back to the user). The system may be used to effectively rewrite the history of generated text when it is incorrectly generated or has been generated and never seen by the user, perhaps due to user or system interruption. The modified, rewritten or truncated history may then be used for subsequent LLM prompts to synchronize the context that the user and the LLM have. As used herein, synchronizing a chat may refer to removing content from a chat history, not adding something generated by the LLM to the chat history, or otherwise modifying the chat history for accuracy based on what has been presented on the client side.

The active listening mechanism described herein may communicate with a client-side application such as a chatbot application to determine that an interruption has occurred and at what point in the response it has been rendered back to the user of the chatbot application. The system may use the information determined from the client side to modify the chat history or transcript of the conversation that is stored at the server side. For example, the user may interrupt the conversation while the server is receiving a response generated by an LLM. By determining how much of the response has been presented to the user, the server may truncate the chat history at the point of the interruption such that subsequent communications with the LLM provide a chat history that more accurately indicates the user’s context as opposed to what the LLM has already generated.

In an example configuration, a server component may be positioned between the client-side application and the LLM being used for the chatbot conversation. The server may receive the user’s message and create and compose a chat history that may be further updated as the conversation evolves. The current chat history, which in this example begins with the user’s initial request, may be sent to the LLM as a prompt or as an input to generate a prompt for the LLM. The LLM may begin generating its response and, in a streaming scenario, the server receives the response as it is generated and returns that to the server application.

At the point where the user interrupts the response, e.g., by selecting a “stop” option during the text generation, the client application has displayed a portion of the response. However, in some cases, the server has received additional content from the LLM that has not yet been displayed to the user. The server may have received yet more information that has not yet been sent to the client application. As such, for the additional information, the server side and the LLM may believe that more has been provided to the user than what has been provided. Moreover, it can be appreciated that LLM may continue to generate the remainder of its response while the client-side application has effectively interrupted or stopped displaying further content.

Without knowing what the last portion of the response displayed was (e.g., the last token displayed) by the client-side application, the server and/or the LLM may respond with different answers that are not consistent with what the user has seen or heard in the case of a spoken conversation with an LLM. To address this lack of synchronicity, the server may determine where the interruption occurred and revise or rewrite the chat history up to and including the last token rendered, or never add certain content to the chat history. The subsequent prompt to the LLM with the rewritten chat history allows the LLM to have the context of where the previous response was interrupted so that the actual last word presented to the user can be identified by the LLM.

In another example, the user may follow up with a clarification, such that the response from the LLM may be irrelevant. As such, to avoid confusion at the client side, the server side may rewrite the chat history to delete the previous response and prompt the LLM with the revised request accordingly.

In one aspect, there is provided a computer-implemented method, comprising receiving an indication of an interruption in a messaging conversation at a client application; determining a last presented portion of a response, the response generated by an LLM for the messaging conversation and provided to the client application in response to prompting the LLM with a prompt based on at least a first input provided to the client application; and modifying a chat history maintained by a server application based on the last presented portion of the response.

In certain example embodiments, the last presented portion is communicated by the client application to the server application responsive to detecting the interruption in the messaging conversation.

In certain example embodiments, the method further includes subsequent to the interruption, receiving a second input provided to the client application; and modifying the chat history by: removing, from the chat history, at least a portion of the response received by the server application from the LLM but not presented by the client application; and adding the second input to the chat history.

In certain example embodiments, the entire response received by the server application from the LLM is discarded.

In certain example embodiments, the last presented portion of the response generated by the LLM corresponds to nothing.

In certain example embodiments, the last presented portion of the response generated by the LLM corresponds to a last presented token.

In certain example embodiments, the response generated by the LLM is streamed to the client application by the server application.

In certain example embodiments, the method further includes further prompting the LLM using the modified chat history.

In certain example embodiments, the interruption is initiated by selection of a stop option.

In certain example embodiments, the interruption is initiated by composition of a further message in the messaging conversation.

In certain example embodiments, detecting composition comprises detecting a first entered character.

In certain example embodiments, detecting composition comprises detecting entry of a next message in the messaging conversation.

In certain example embodiments, the method further includes receiving the first input from the client application; using the first input to generate a first prompt; sending the first prompt to the LLM; receiving the response generated by the LLM; and sending the response to the client application in a plurality of portions.

In certain example embodiments, the last presented portion corresponds to one of the plurality of portions.

In certain example embodiments, at least one of the plurality of portions is received by the server application subsequent to the last presented portion.

In certain example embodiments, the first input and/or the last presented portion of the response is associated with a voice input.

In certain example embodiments, the voice input is used to generate a text input for the messaging conversation, the text input corresponding to the first input.

In certain example embodiments, the first input and/or the last presented portion of the response comprises a text input.

In another aspect, there is provided a computer system comprising at least one processor and at least one memory, the at least one memory comprising processor executable instructions that, when executed by the at least one processor, cause the computer system to: receive an indication of an interruption in a messaging conversation at a client application; determine a last presented portion of a response, the response generated by an LLM for the messaging conversation and provided to the client application in response to prompting the LLM with a prompt based on at least a first input provided to the client application; and modify a chat history maintained by a server application based on the last presented portion of the response.

In another aspect, there is provided a computer-readable medium comprising processor executable instructions that, when executed by a processor of a computer system, cause the computer system to: receive an indication of an interruption in a messaging conversation at a client application; determine a last presented portion of a response, the response generated by an LLM for the messaging conversation and provided to the client application in response to prompting the LLM with a prompt based on at least a first input provided to the client application; and modify a chat history maintained by a server application based on the last presented portion of the response.

In another aspect, there is provided a computer-implemented method comprising: responsive to detecting an interruption in an electronic conversation at a client application, determining a last presented portion of a response, the response generated by an LLM for the electronic conversation and received by the client application in response to prompting the LLM with a prompt based on at least a first input provided to the client application; and providing an indication of the interruption and the last presented portion of the response to a server application to have the server application modify a chat history maintained by the server application based on the last presented portion of the response.

In another aspect, there is provided a computer-implemented method comprising: receiving, by a client application, a first input associated with an electronic conversation at the client application; prompting, by a server application, an LLM with a prompt based on at least the first input; receiving, by the client application, a response to the prompt generated by the LLM; detecting an interruption in an electronic conversation at the client application; receiving, by the server application, an indication of the interruption; determining, by the server application, a last presented portion of the response; and modifying a chat history maintained by a server application based on the last presented portion of the response.

The interruption at the client side may occur due to various events, such as a stop request (e.g., as noted above), a connection or transmission issue that is detectable by the client application (e.g., the LLM response was cut off during transmission), or a follow up message from the user. For example, the user may pose an initial question or request and while the LLM has begun responding, clarify the question. The follow up message may be detected when the user begins composing a next message or upon sending that message.

The detected interruption may be used to initiate a chat history synchronization process such as that described herein, wherein an indication of the interruption and where/when it occurred (e.g., based on the last token that was displayed) is communicated to the server side. The generated text being received from the LLM at the server device may continue to be received and buffered by the server device but delivery to the client side device may be paused in response to the interruption signal. The client device may, in the same or in an additional communication, indicate where the interruption occurred, for example, by indicating the last token displayed, where a text-to-speech rendering was stopped (e.g., a timestamp), etc.

By determining an indication of the interruption and when or where the interruption occurred, the server device may revise the chat history or transcript maintained by the server device to discard content that was generated but not presented to the user. Due to this synchronization, subsequent prompts to the LLM may provide a more accurate context of what the user has actually seen or had a chance to see, rather than what the LLM has previously generated.

The client-side application, such as one providing a chatbot UI, may include a tool, plug-in, utility or other software module to detect interruptions. The same or an additional tool, plug-in, utility or software module may be used to determine where or when the rendered response was interrupted, that is, what was the last content presented to the user. Determining where or when the rendered response was interrupted may be embedded in the chat application and be determined in response to detecting the interruption (e.g., when stop button selected, determine last rendered token). Determining when the rendered response was interrupted may be performed by an associated tool or module such as a text-to-speech or speech-to-text generator used to compose messages based on a voice exchange with the chatbot application. For example, the speech-to-text generator may include a listener to detect a follow-up utterance from the user while an LLM response is being generated and determine what the text-to-speech generator has already played back to the user to synchronize the chat history associated with the voice conversation.

In an implementation, the client application may detect that the user has begun typing while a response is being streamed. The user may be responding to something they have already seen in the response or may be pre-emptively asking a follow-on question. The system may pause the display of the streamed response, immediately or at some cutoff point (e.g., at the end of the next sentence), while still receiving the tokens from the LLM. The cutoff may, additionally or alternatively, occur at the server application that is interposed between the client application and the LLM.

The system may determine whether the question is related to the portion of the response that the user had seen when they started typing. For example, the system may keep track of the time the user started typing and correlate it with what was already rendered at that time. The system may terminate a function call such as if the system is performing a search of external data (e.g., retrieval augmented generation (RAG), mixture of experts (MoE), tool calling, function calling, etc.). The system may modify the chat message history accordingly, for example, by removing the generated portion altogether from the chat history or keeping only the portion that was already rendered and displayed to the user (e.g., if the follow-on question relates to the portion that was displayed). Detection of user interruption may be the first key typed, or the enter key being typed or similar action.

The active listening module may communicate with a chat history synchronizer operating on/with the chatbot server application to detect interruptions and communicate an indication that the interruption occurred and what was the most recent token or portion of the response, to enable the chat history to be revised for subsequent prompts to the LLM.

It can be appreciated that the configurations described above are illustrative of one example and that other configurations are possible. For example, to synchronize the chat history, transcript or log between the client side and the server side based on what the UI has done so that an accurate history may be fed back into the LLM in a subsequent call, any one or more entities coupled in different combinations may be used. The LLM may be more tightly coupled to the chatbot server application with a remote application programming interface (API) or local interface used as applicable. Alternatively, a multitude of such entities may be located on a single computing device (e.g., in a PC, smart speaker or smart phone) with local instead of remote interfaces used to synchronize the chat history.

### Synchronizing Chat Histories used in Prompting LLMs

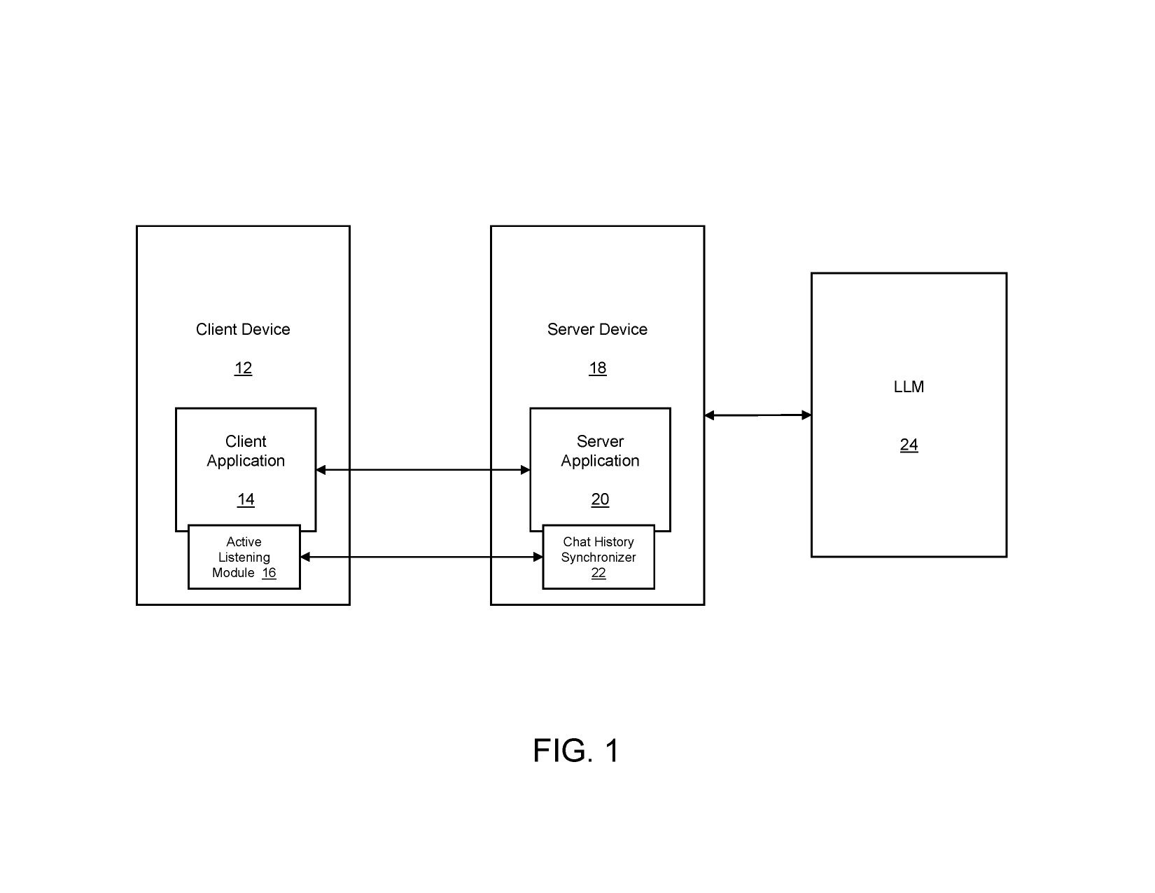

Referring now to the figures, FIG. 1 illustrates an example of a computing environment 10 in which a client device 12 communicates with a server device 18 to have a client application 14 communicate with a server application 20. The server device 18 is in communication with an LLM 24 to enable the server application 20 to prompt the LLM 24 to generate responses to user messages generated in the client application 14 on the client device 12. For example, the client application 14 may provide an ability to participate in electronic messaging conversations via a UI with another party, such as a chatbot that utilizes the LLM 24 to generate responses to user messages.

The configuration and number of separate entities 12, 18, 24 shown in FIG. 1 are illustrative and other configurations are possible. For example, a client device 12 communicating with a single device that hosts both the server application 20 and the LLM 24, a single device providing both the client and server operations in communication with another entity providing the LLM 24, a single device providing all client, server, and LLM operations, etc.

Such computing devices 12, 18 (or computing systems) may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a virtual reality device, an augmented reality device, etc.

The client device 12, server device 18 and any device or system hosting the LLM 24 may be connected to each other over one or more communication networks (not shown). Such communication network(s) may include a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The client application 12 may take the form of a mobile-type application (also referred to as an “app” – as illustrated), a desktop-type application, an embedded application in customized computing systems, or an instance or page contained and provided within a web/Internet browser, to name a few.

The LLM 24 may be provided by a separate computing device or computing system, by a separate entity or may be integrated with the server application 20 within the same computing device or computing system. As such, the configuration shown in FIG. 1 is illustrative and other computing device/system configurations are possible. For example, the computing environment 10 shown in FIG. 1 may represent a single device such as a portable electronic device or the integration/cooperation of multiple electronic devices such as separate client and server devices 12, 18 or a client device 12 and a remote or offsite storage or processing entity or service. That is, the computing environment 10 may be implemented using any one or more electronic devices including standalone devices and those connected to offsite storage and processing operations (e.g., via cloud-based computing storage and processing facilities).

In the example shown in FIG. 1, the client application 14 includes or is otherwise in communication with an active listening module 16. The active listening module 16 may communicate directly or indirectly via the client application 14 with a chat history synchronizer 22. The active listening module 16 and chat history synchronizer 22 may be used to detect interruptions in an electronic messaging conversation, determine what has been presented to the user via the client application 14, and have the chat history synchronizer 22 synchronize what has been presented with what has been generated by the LLM 24 and received by the server application 18.

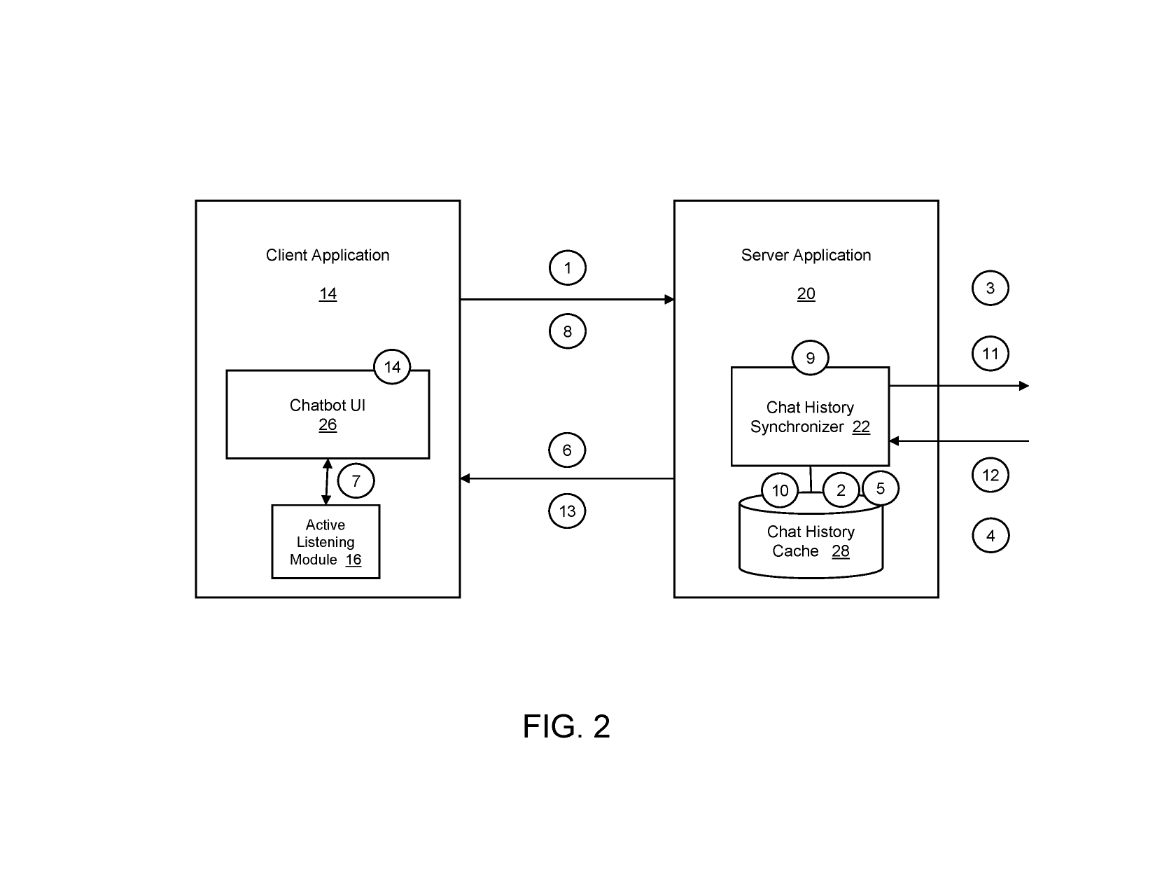

Referring now to FIG. 2, further detail is provided to illustrate communications exchanged between the client application 14 and the server application 20 in utilizing the active listening module 16 and the chat history synchronizer 22. The client application includes a chatbot UI 26. The chatbot UI 26 may be the primary functionality provided by the client application 14 or may be a sub-set, window, tab, widget or function within the client application 14. The chatbot UI 26 is coupled to the active listening module 16 to monitor the messaging exchange or other inputs to the chatbot UI 26 to determine interruptions in a messaging conversation and to enable the chat history synchronizer 22 to edit, rewrite, augment or otherwise modify a chat history associated with the messaging conversation; or, as noted above, never haver certain content added to the chat history to begin with. The chat history synchronizer 22 includes or has access to a chat history cache 28, which may be used to store chat histories generated during the messaging conversation. The chat histories stored in the chat history cache 28 may be used by the server application 20 to prompt the LLM 24. In this way, the LLM 24 may respond to a latest user message with the context provided by the chat history to generate more accurate or relevant responses.

In operation, the client application 14 provides a user message to the server application 20. The server application 20 may update a chat history (e.g., stored in the chat history cache 28) with the user message and provide the chat history to the LLM 24 to process the latest user message in the context of the chat history. The LLM may begin replying as a response is generated, e.g., by streaming the response to the client application 14 via the server application 20. The server application 20 may thus facilitate providing the response generated by the LLM 24 to the chatbot UI 26. In a streaming implementation, the server application 20 may send portions of the response (e.g., tokens) to the client application 14 as they are received. As such, at any point in time, the amount of content generated by the LLM 24 may be more than has been received by the server application 20, which in turn is more than what has been received by the client application 14 from the server application 20 and presented in the chatbot UI 26.

FIG. 2 also illustrates an example of a messaging sequence to illustrate use of the active listening module 16 and chat history synchronizer 22. At step 1, the client application 14 sends a user message to the server application 20 based on an input to the chatbot UI 26, e.g., a question posed to the chatbot. The server application 20 may create (or update) a chat history for the corresponding conversation at step 2 and prompts the LLM 24 at step 3. The server application 20 receives or begins receiving a response from the LLM 24 at step 4. At step 5, the server application 20 may continue to update the corresponding chat history and begin sending portions of the response received at step 4 to the client application 14 at step 6.

The operations up to step 6 are assumed to be routine messaging and step 6 may continue until all content generated by the LLM 24 is passed to the client application 14 to be presented in the chatbot UI 26. However, in this example, an interruption signal is detected by the active listening module 16 at step 7. For example, the user may have selected a “stop” option or followed up with an additional message that changes the context or obviates the need for the initial response that has begun to stream at steps 4 and 6. The interruption may, additionally or alternatively, relate to a network or system issue such as a slow connection, disrupted connection, buffering or other delay.

The active listening module 16 may determine what was the last content presented to the chatbot UI 26 in the response being received at step 6, e.g., determine what was the last token presented in the chatbot UI 14 when the response is being streamed by the server application 20 to the client application 14. That is, the active listening module 16 may operate to detect an interruption and to determine when the interruption occurred, based on the last presented portion of the response being received from the LLM 24 via the server application 20. At step 8, a notification may be sent by the active listening module 16 to the chat history synchronizer 22 at the server application 20. The chat history synchronizer 22 processes the notification at step 9 to determine what, if any, modifications should be made to the corresponding chat history at step 10. For example, the interruption may change the initial request entirely such that the response being received at step 4 should be ignored and/or discarded. Moreover, the chat history synchronizer 22 may initiate termination of a function call such as if the system is performing a search of external data (e.g., RAG, MoE, tool calling, function calling, etc.). By modifying the chat history based on what the user has actually seen and what, if any, follow-up messages have been received, the chat history synchronizer 22 may provide a more accurate chat history to the LLM 24 in a subsequent call.

In the example shown in FIG. 2, the chat history as modified in step 10 may be used to provide a follow-up prompt to the LLM 24 at step 11, with a different context than would be provided if the entirety of the response at step 4 was kept. In this way, the subsequent LLM response received at step 12 may be more accurately or more completely responsive to the current context affected by the interruption at step 7 and any subsequent content determined from steps 8 and 9. The server application 20 may then send the LLM response to the client application 14 at step 13, to have the chatbot UI 26 updated at step 14. It can be appreciated that in a streaming scenario, the response being received at step 4 may be asynchronously buffered by the server application 20 while steps 5 through 10 occur. However, since the chat history is updated at step 10, the subsequent prompt to the LLM 24 is not out of sync despite the nature and completeness of the LLM’s previous response at step 4.

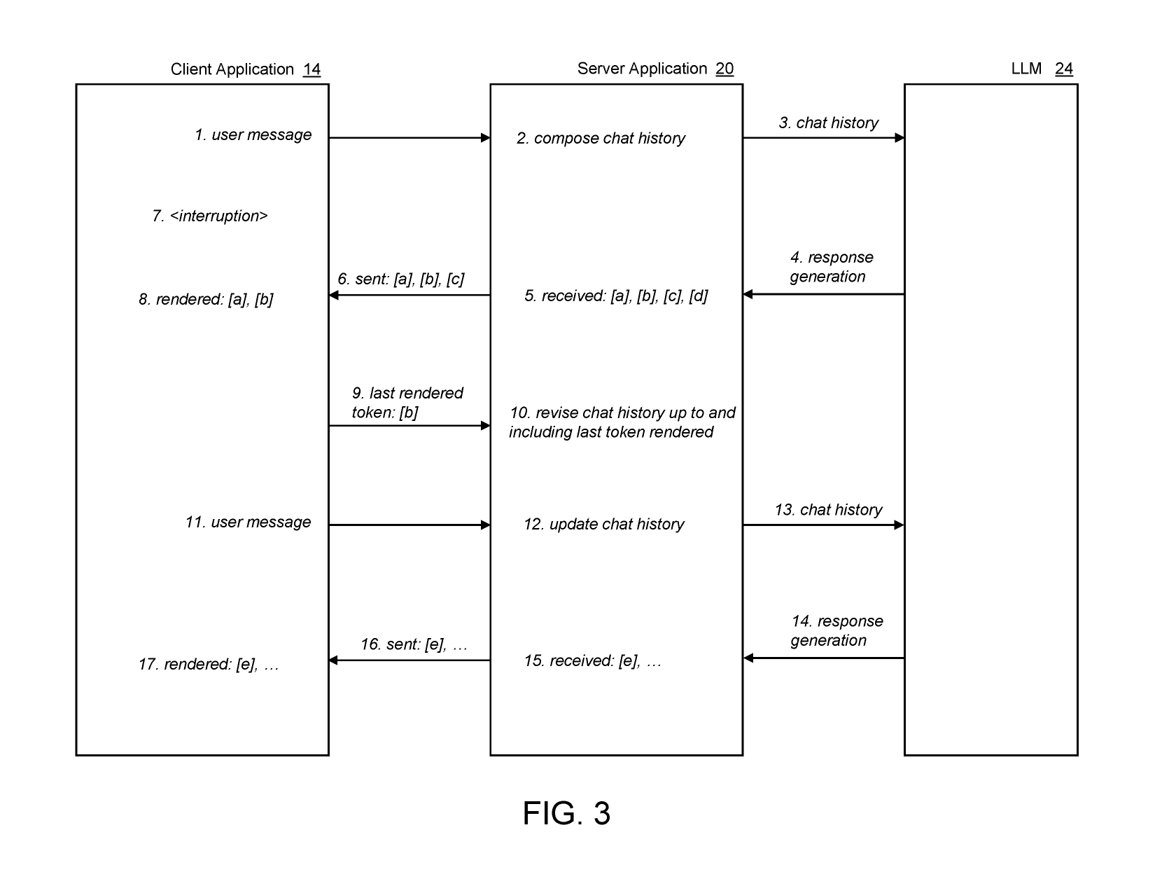

The example shown in FIG. 2 is further illustrated in FIG. 3. In the example shown in FIG. 3, it is assumed that the client application 14 provides user messages as inputs to be processed by the LLM 24 and that the LLM 24 responds with a series of tokens, generally represented in FIG. 3 by [a], [b], [c], etc. Additionally, the example shown in FIG. 3 has the LLM 24 streaming the tokens back to the server application 20 as they are generated. It can be appreciated that the tokens [a], [b], [c],… shown in FIG. 3 may represent any plurality of portions of a response generated by the LLM 24 that is sent to by the server application 20 to the client application 14 using the same or different amounts of content in each portion. That is, while the portions [a], [b], [c], …as received by the server application 20 may differ from the portions sent to the client application 14. Similarly, such portions may differ from the portions presented to the chatbot UI 26 by the client application 14 and consistent references are shown in FIG. 3 for ease of illustration.

At step 1, a user message is provided by the client application 14 to the server application 20. The server application 20 may create or update or otherwise compose a chat history at step 2, using the user message. The chat history is provided at step 3 to the LLM 24 to have a response generated at step 4. In this example, the response generation at step 4 may include streaming tokens or other portions, denoted by [a], [b], [c], [d] at step 5. At step 6, the server application 20 is sending the received tokens to the client application 14 and so far has sent [a], [b], [c]. At step 7, an interruption has occurred at the client application 14, e.g., by the user interrupting the messaging conversation in some way. At this time, the client application 14 has had the chatbot UI 26 render only tokens [a] and [b]. As such, the active listening module 16, in addition to detecting the interruption at step 7 determines that the last rendered token was token [b], which may be communicated back to the server application 20 at step 9. It can be appreciated that the notification associated with step 9 may be sent in-band or out-of-band to the chat history synchronizer 22 via a connection between the client application 14 and server application 20 or some other channel.

At step 10, the server application 20 may use the chat history synchronizer 22 to revise the chat history up to and including the last token rendered, which may include editing or removing content from the chat history or never adding certain content to the chat history to begin with. That is, the chat history may be revised to include the user message and tokens [a] and [b] as the response presented to the user at the time of the interruption. At step 11, a subsequent user message may be received, e.g., a follow up message or selection of a resume button. The chat history may be updated again at step 12 according to the content in the user message sent at step 11. For example, if the subsequent user message clarifies a question, the chat history may be updated with the new inquiry. However, if the subsequent user message at step 11 is merely to resume streaming the response from step 4, the server application 20 may access a buffer or cache or re-prompt the LLM 24 if necessary, to resume streaming at token [c].

The updated chat history is used at step 13 to provide a further prompt to the LLM 24, which initiates a new response being generated at step 14. In this example, it is assumed that the subsequent user message at step 11 results in the responses at steps 4 and 14 being different such that a new token [e] is received by the server application 20 at step 15 and sent to the client application 14 at step 16 such that it may be rendered in the chatbot UI 26 by the client application 14 at step 17.

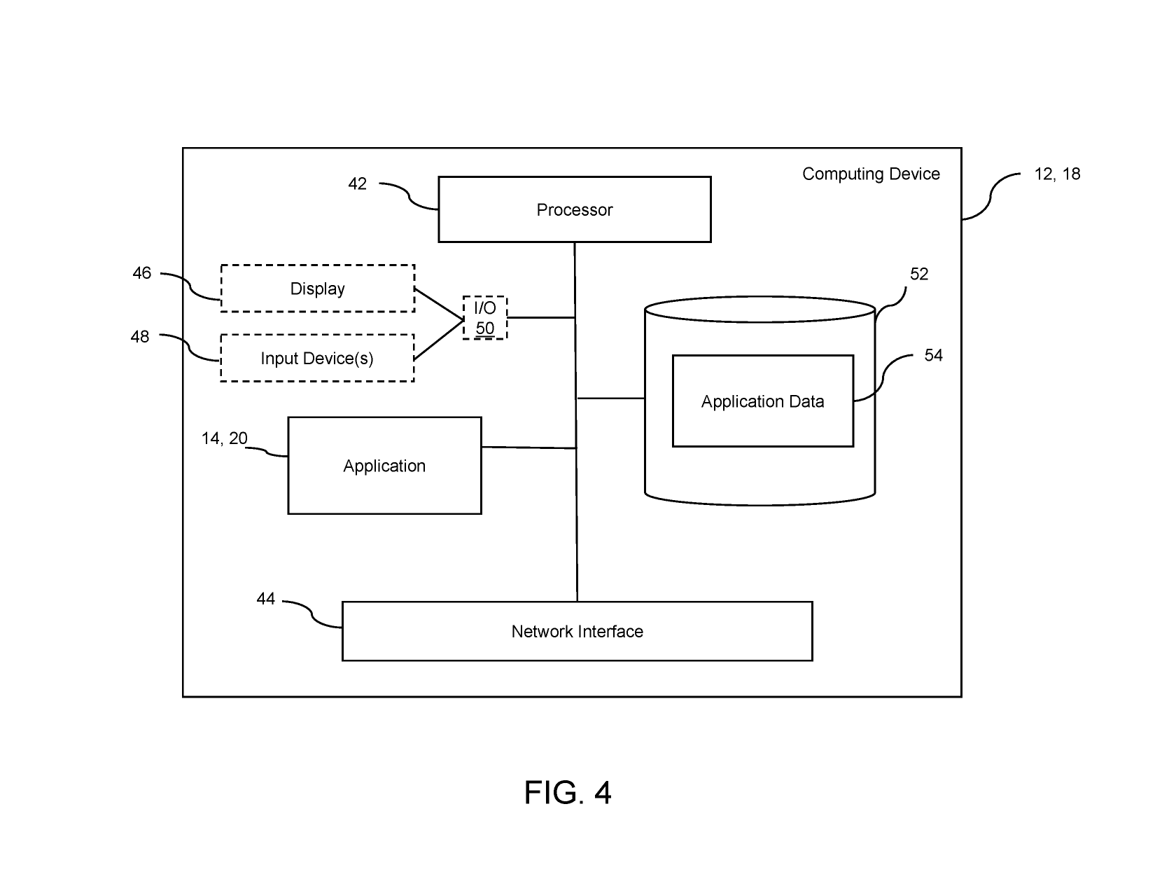

FIG. 4 shows an example of a computing device 12, 18 which may be utilized by any one or more of the entities shown in FIGS. 1-3, for example, the client device 12 or server device 18 or other computing device or computing system used to host the LLM 24.

In this example, the computing device 12, 18 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 12, 18 may also include an application 14, 20 (or other application(s)), a data store 52, and client application data 54. Although not shown in FIG. 4, the active listening module 16 and chat UI 26 or chat history synchronizer 22 and chat history cache 28 may be hosted by the computing device 12, 18, e.g., depending on whether it is a client device 12 or server device 18.

The data store 52 may represent a database or library or other computer-readable medium configured to store data and permit retrieval of data by the computing device 12, 18. The data store 52 may be read-only or may permit modifications to the data. The data store 52 may also store both read-only and write accessible data in the same memory allocation. In this example, the data store 52 stores the application data 54 for the application 14, 20 that is configured to be executed by the computing device 12, 18 for a particular role or purpose.

While not delineated in FIG. 4, the computing device 12, 18 includes at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 12, 18 to operate together as described herein. FIG. 4 illustrates examples of modules and applications stored in memory on the computing device 12, 18 and executed by the processor(s) 42.

It can be appreciated that any of the modules and applications shown in FIG. 4 may be hosted externally and may be available to the computing device 12,18, e.g., via a network interface 44. The data store 52 in this example stores, among other things, the application data 54 that can be accessed and utilized by the application 14, 20. The data store 52 may additionally store one or more software functions or routines in a cache or in other types of memory.

As shown in FIG. 4, the computing device 12, 18 may, optionally (e.g., when configured as a personal electronic device such as a smartphone or tablet), include a display 46 and one or more input device(s) 48 that may be utilized via an input/output (I/O) module 50. That is, such components may be omitted when the computing device 12, 18 does not interact with a user.

While examples referred to herein may refer to a single display 46 for ease of illustration, the principles discussed herein may also be applied to multiple displays 46, e.g., to view portions of UIs 26 rendered by or with the application 14 on separate side-by-side screens on a client device 12. That is, any reference to a display 46 may include any one or more displays 46 or screens providing similar visual functions. The application 14 may receive one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 12.

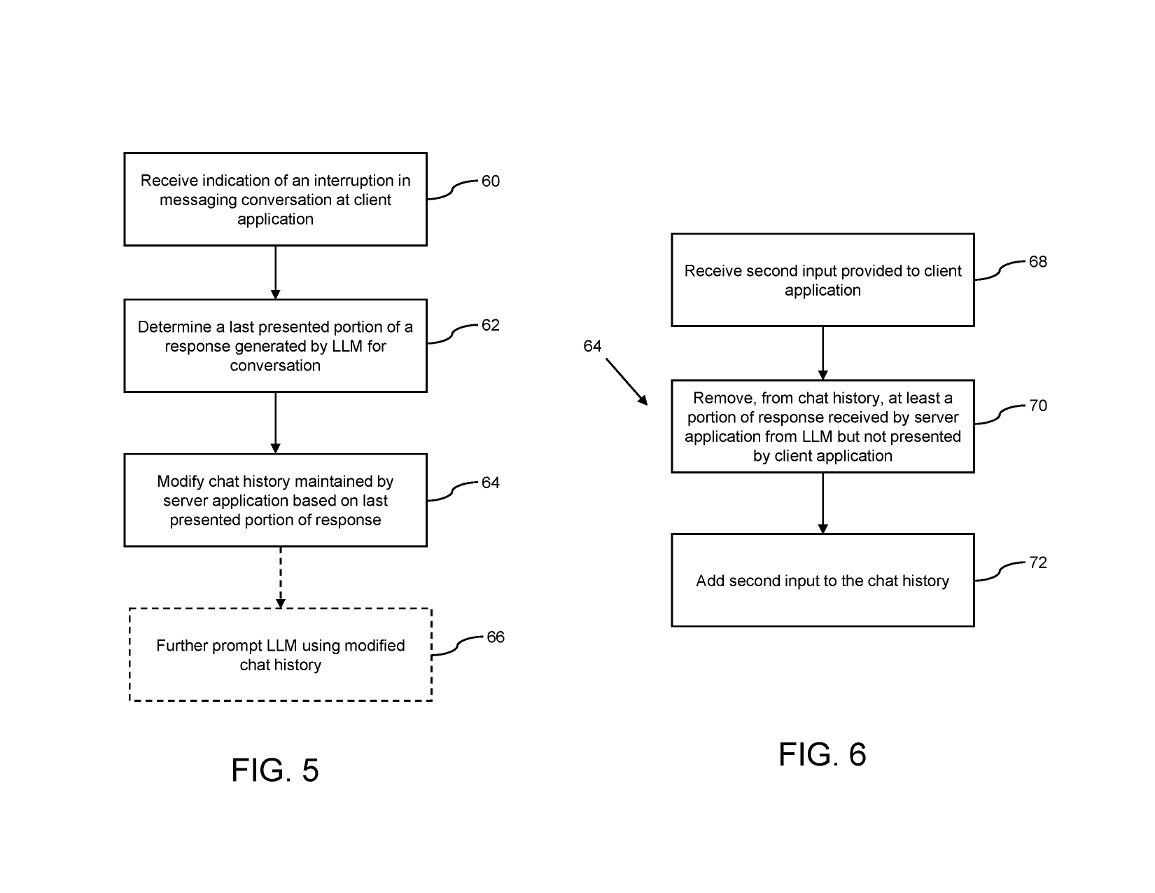

Referring now to FIG. 5, a flow chart is provided illustrating example operations for synchronizing chat histories used in prompting LLMs 24, from the perspective of a server-side entity such as the server device 18 and/or computing device or system hosting the LLM 24.

At block 60, the server application 20 at the server device 18 may receive an indication from the client device 12, of an interruption in a messaging conversation at the client application 14, e.g., as detected by the active listening module 16.

At block 62, the server application 20 may use the chat history synchronizer 22 to determine a last presented portion of a response generated by the LLM 24 for the messaging conversation. For example, the server application 20 may be notified by the client application 14 of both the existence of the interruption and the last portion (e.g., token) that was presented in the chatbot UI 26.

The chat history synchronizer 22 may, at block 64, modify the chat history maintained by the server application 20 (e.g., in the chat history cache 28) based on the last presented portion of the response.

Optionally, as depicted using dashed lines, the server application 20 may further prompt the LLM 24 using the modified chat history, e.g., upon a resumption event such as a “resume” or follow-up message provided by the client side.

An example of modifying the chat history based on a further input is shown in FIG. 6, and these operations may be performed at or in connection with block 64 in FIG. 5.

At block 68, a second input provided to the client application 14 is received by the server application 20. At block 70, at least a portion of the initial (or prior) response that was received by the server application 20 may be removed from the chat history, e.g., to account for content in the second input. The portion of the chat history that is removed may correspond to portion(s) of content that were received by the server application 20 from the LLM 24 but not presented by the client application 14, e.g., as illustrated in FIG. 3.

At block 72, the second input may be added to the chat history such that a further prompt to the LLM 24 (e.g., see block 66 in FIG. 5) accounts for the second input and any change to the inquiry and/or context of the messaging conversation.

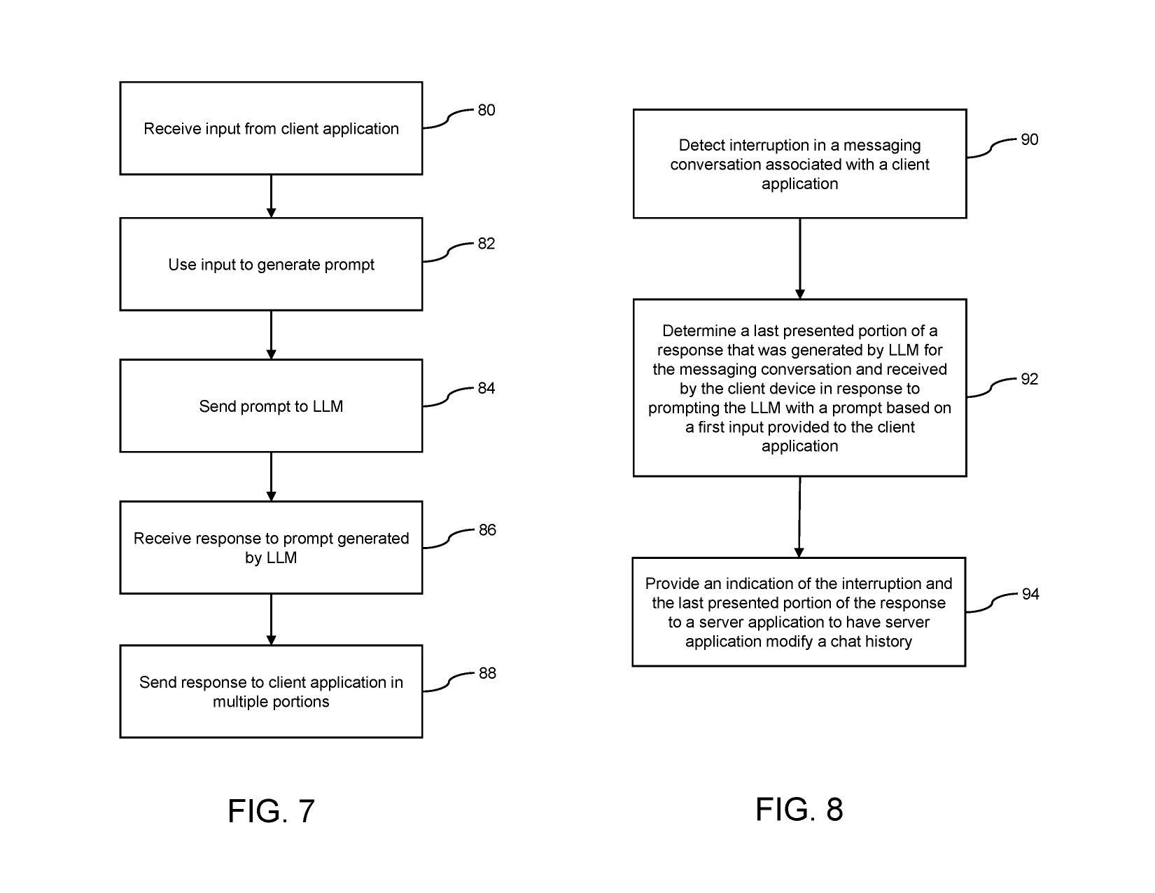

Referring now to FIG. 7, a flow chart is provided illustrating another set of example operations for synchronizing chat histories used in prompting LLMs 24, from the perspective of the server device 18.

At block 80, the server application 20 may receive an input from the client application 14, e.g., a user message. At block 82, the server application 20 uses the input to generate a prompt for the LLM 24. The prompt may be sent to the LLM 24 at block 84 and response generated by the LLM 24 may be received by the server application 20 at block 86. The response generated by the LLM 24 may be sent to the client application 14, by the server application 20 at block 88, in this example in multiple portions, e.g., by streaming tokens or other constituent elements of the response that is generated by the LLM 24.

FIG. 8 illustrates operations that may be performed in synchronizing chat histories used in prompting LLMs 24, from the perspective of the client device 12.

At block 90, an interruption in a messaging conversation is detected at the client side, e.g., by the active listening module 16. At block 92, the active listening module 16 may determine a last presented portion of a response that was generated by the LLM 24 for the messaging conversation. The response has been received by the client device 12 in response to prompting the LLM 24 with a prompt based on a first input that was provided to the client application 14 by, e.g., a user.

At block 94, an indication of the interruption and the last presented portion of the response may be provided to the server application 20 to have the server application 20 modify a chat history, e.g., as shown in FIGS. 2 and 3.

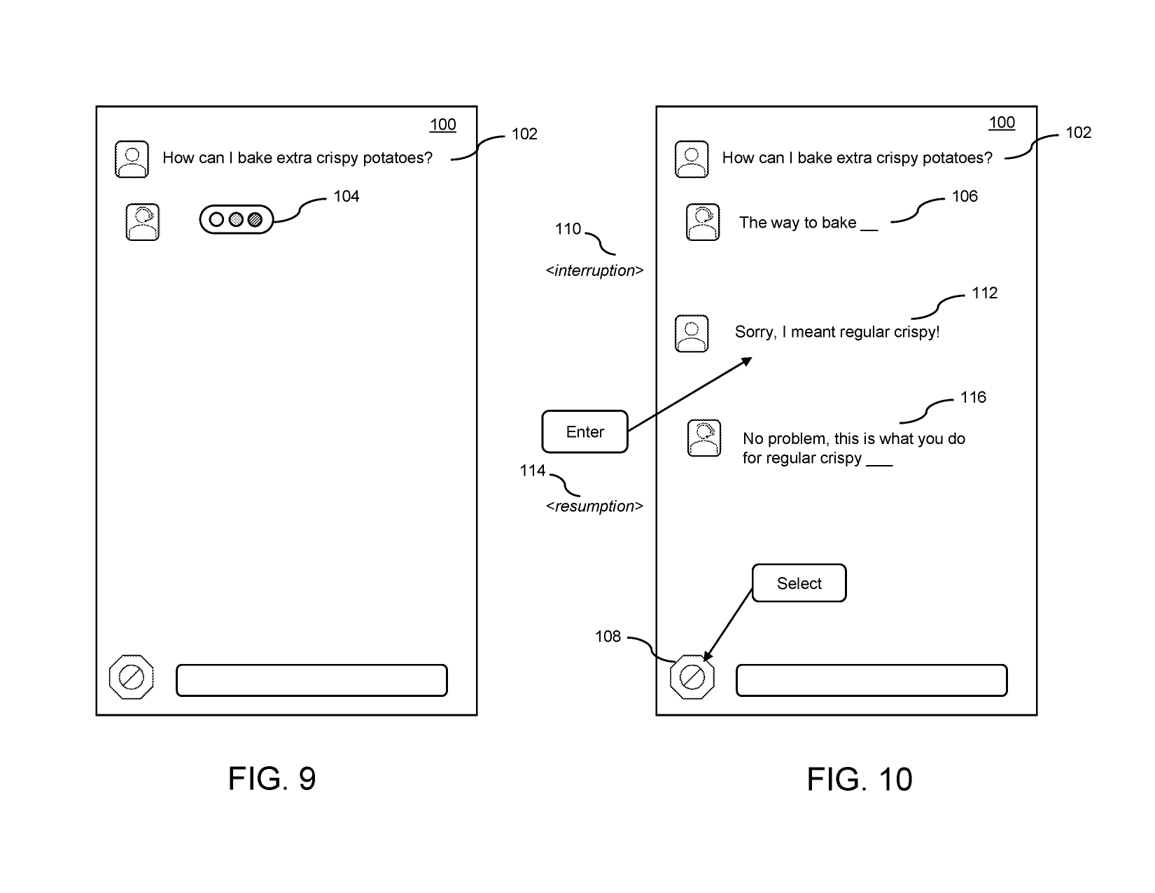

Referring now to FIG. 9, an example of a UI page 200, e.g., presented by the chatbot UI 26 is shown, e.g., for conducting a conversation with a chatbot that utilizes an LLM 24 to assist with queries, questions, or other requests. The UI 200 in this example displays a first message 102 from the user: “How can I bake extra crispy potatoes?”. In response, the UI 200 displays a progress animation 104 to indicate that the chatbot is working on a reply, which the LLM 24 is being prompted and a response is being received by the server device 18.

As shown in FIG. 10, a first portion 106 of the response has been presented, e.g., is being streamed to the UI 100, in this example: “The way to bake_”. An interruption 110 is detected, in this example by detecting selection of a stop button 108. Following the interruption 110, the user composes and provides a second message 112: “Sorry, I meant regular crispy!”. The user may then select a resume button (not shown) or the resumption 114 may be automatically initiated responsive to receiving the second input 112. In this example, the chatbot may begin returning a new response 116: “No problem, this is what you do for regular crispy_”. It can be appreciated that in response to entering the second message 112 and the resumption 114, the chat history synchronizer 22 may revise the chat history and re-prompt the LLM 24 from the server side such that the client side sees a logical progression in the messaging conversation without incorrect content related to extra crispy potatoes.

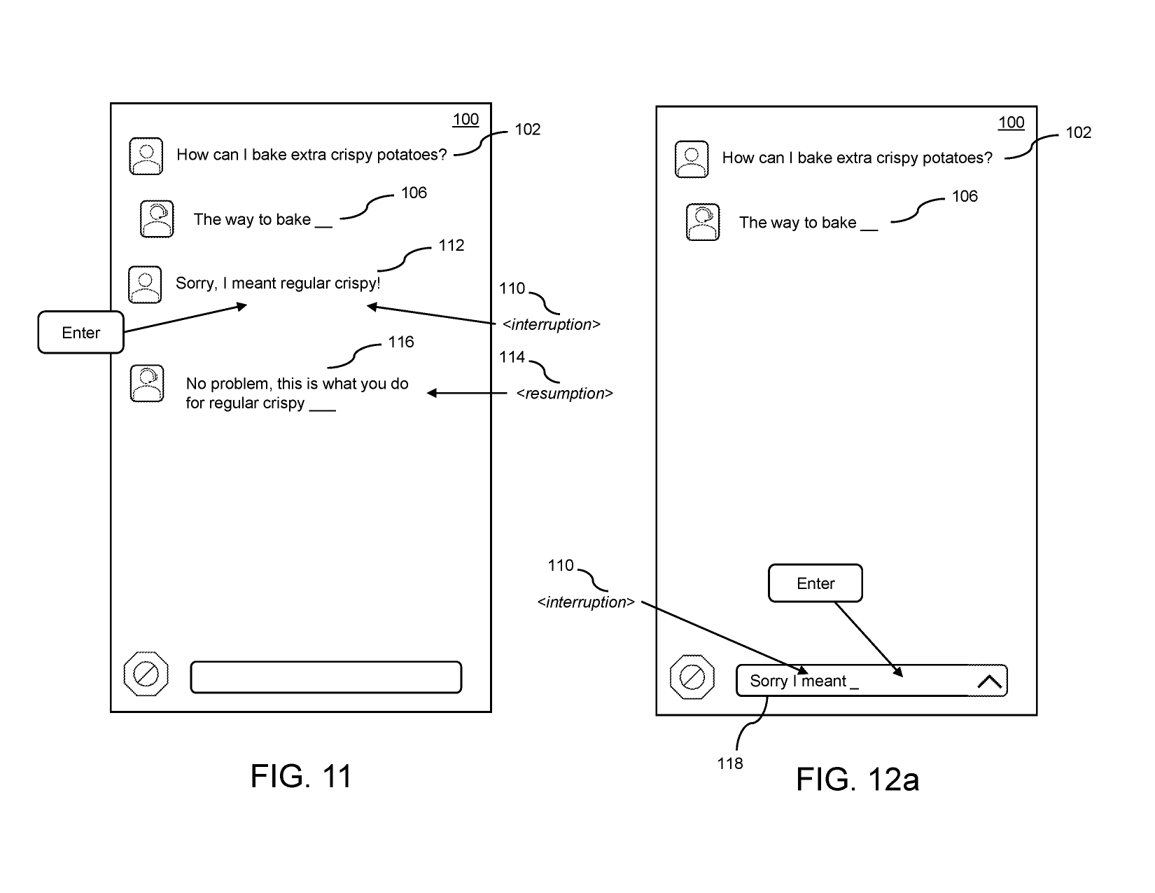

FIG. 11 illustrates another example of an interruption 110 and resumption 114 wherein the interruption 110 is triggered by the second message 112 being presented in the UI 100. In this example, the server side may revise the chat history and re-prompt the LLM 24 in the background such that the response 116 carries on the messaging conversation in the same logical manner as shown in FIG. 10.

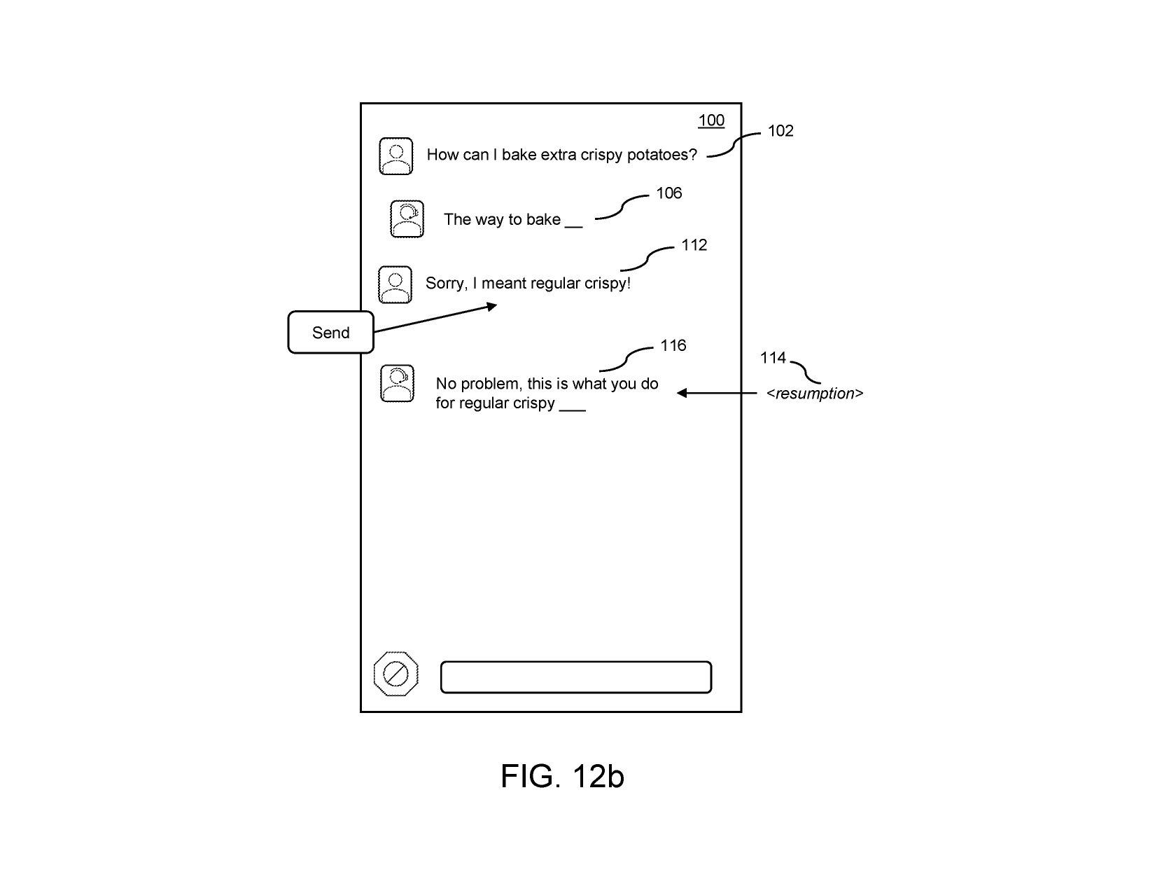

FIGS. 12a and 12b illustrate yet another example of an interruption 110 and resumption 114. In FIG. 12a, the interruption 110 is triggered by detecting the composition of the second message 112 in a text entry field to more quickly identify that the user is following up. Then, after entering and presenting the second message 112 as shown in FIG. 12b, the messaging conversation may carry on in the same logical manner as shown in FIGS. 10 and 11.

With respect to the LLM 24, examples of generative models that may be used include, for example, OpenAI’s Generative Pre-trained Transformer family (GPT 3.5, GPT 4, ChatGPT), Meta’s Llama and Llama 2, CohereAI’s Command, Mistral/Mixtral, Anthropic’s Claude, Google’s Gemini, Gemma and Bard. These general purpose and chat-focused models may be used as both the first and second model. It can be appreciated that, in addition, more specialized models may be used as the first or second model. For example, if the error in the first model is related to code generation then a generative model specializing in code generation may be used as the second model - the Code Llama, HuggingFace’s CodeGen, Github Copilot’s Codex model or similar may be used. In some cases, instead of text generation models, multimodal or multimedia models may be used such as BLIP-2, CLIP, or GPT-4V. These may be used to analyze user interfaces or user interface elements, or generate user interfaces or user interface elements.

It can be appreciated that although transformer-based language models are described herein, the present disclosure may be applicable to any ML-based language model, including language models based on other neural network architectures such as recurrent neural network (RNN)-based language models. Indeed, the consideration of an LLM 24 above is by way of example and the present disclosure and principles are not necessarily so limited. For example, the techniques described above may be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM 24 in it, may be employed in association with the above-discussed techniques.

### Neural Networks and Machine Learning

To assist in understanding the present disclosure, some concepts relevant to neural networks and machine learning (ML) are discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), RNNs, and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

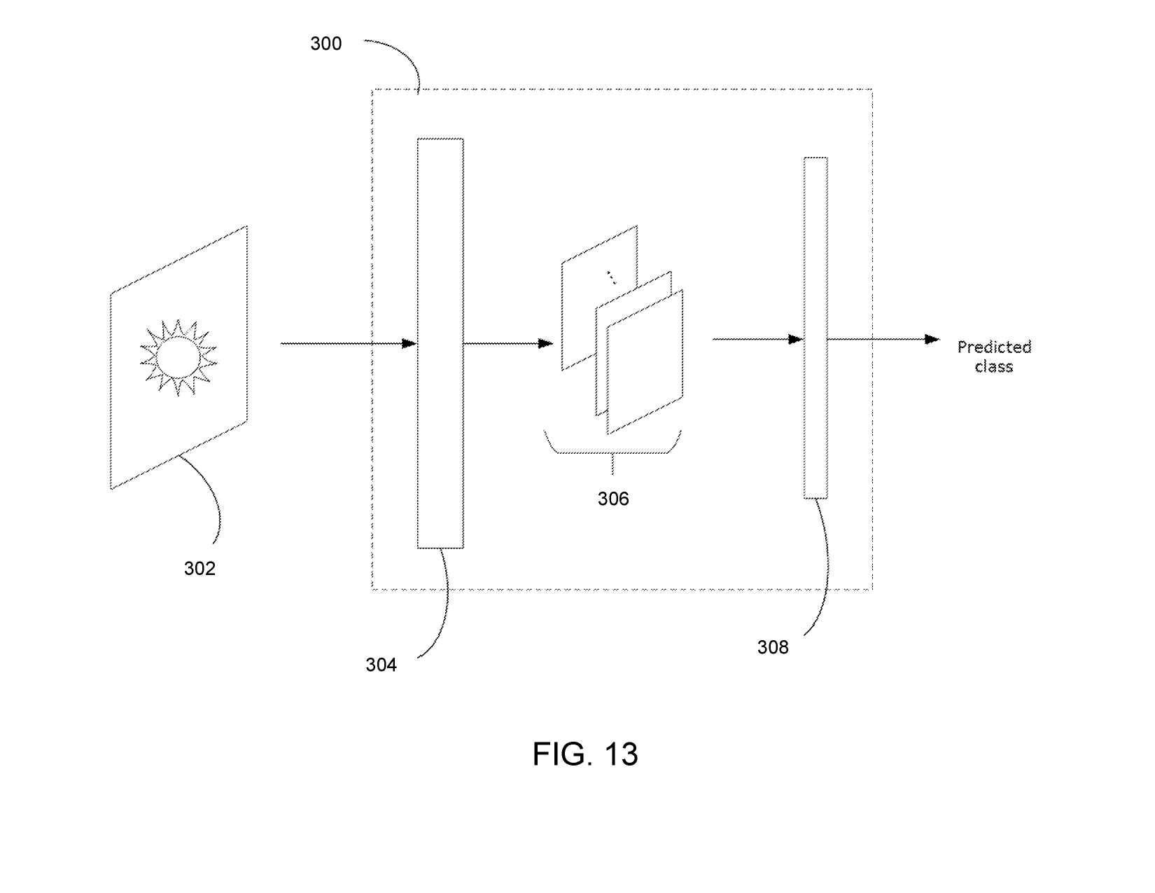

FIG. 13 is a simplified diagram of an example CNN 300, which is an example of a DNN that is commonly used for image processing tasks such as image classification, image analysis, object segmentation, etc. An input to the CNN 300 may be a 2D RGB image 302.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when applied to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs 24.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of an LLM 24 may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

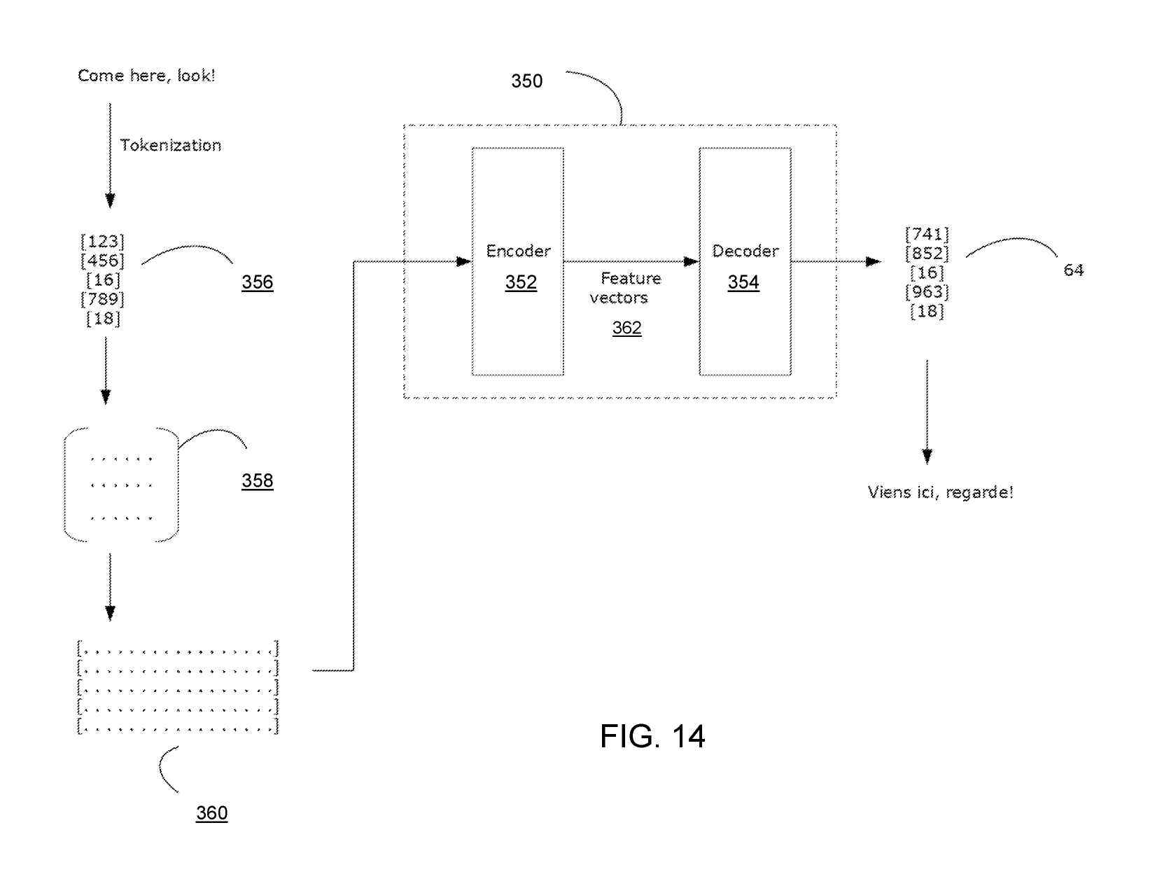

FIG. 14 is a simplified diagram of an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labelled (e.g., annotated to indicate verbs, nouns, etc.) or unlabelled. LLMs 24 may be trained on a large unlabelled corpus. Some LLMs 24 may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 14, a short sequence of tokens 356 corresponding to the text sequence “Come here, look!” is illustrated as input to the transformer 350. Tokenization of the text sequence into the tokens 356 may be performed by some preprocessing tokenization module such as, for example, a byte pair encoding tokenizer (the “pre” referring to the tokenization occurring prior to the processing of the tokenized input by the LLM 24), which is not shown in FIG. 14 for simplicity. In general, the token sequence that is inputted to the transformer 350 may be of any length up to a maximum length defined based on the dimensions of the transformer 350 (e.g., such a limit may be 2048 tokens in some LLMs 24). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (i.e., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs 24. An example GPT-type LLM 24 is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM 24, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an API). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 24 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 24 may be referred to as a prompt, which is a natural language input that includes instructions to the LLM 24 to generate a desired output. A computing system may generate a prompt that is provided as input to the LLM 24 via its API. As described above, the prompt may optionally be processed or preprocessed into a token sequence prior to being provided as input to the LLM 24 via its API. A prompt can include one or more examples of the desired output, which provides the LLM 24 with additional information to enable the LLM 24 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any entity within the computing environment 10 such as the computing device 12, 18; any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
receiving an indication of an interruption in a messaging conversation at a client application;
determining a last presented portion of a response, the response generated by a large language model (LLM) for the messaging conversation and provided to the client application in response to prompting the LLM with a prompt based on at least a first input provided to the client application; and
modifying a chat history maintained by a server application based on the last presented portion of the response.

2. The method of claim 1, wherein the last presented portion is communicated by the client application to the server application responsive to detecting the interruption in the messaging conversation.

3. The method of claim 1, further comprising:
subsequent to the interruption, receiving a second input provided to the client application; and
modifying the chat history by:
removing, from the chat history, at least a portion of the response received by the server application from the LLM but not presented by the client application; and
adding the second input to the chat history.

4. The method of claim 3, wherein the entire response received by the server application from the LLM is discarded.

5. The method of claim 1, wherein the last presented portion of the response generated by the LLM corresponds to nothing.

6. The method of claim 1, wherein the last presented portion of the response generated by the LLM corresponds to a last presented token.

7. The method of claim 1, wherein the response generated by the LLM is streamed to the client application by the server application.

8. The method of claim 1, further comprising further prompting the LLM using the modified chat history.

9. The method of claim 1, wherein the interruption is initiated by selection of a stop option.

10. The method of claim 1, wherein the interruption is initiated by composition of a further message in the messaging conversation.

11. The method of claim 10, wherein detecting composition comprises detecting a first entered character.

12. The method of claim 10, wherein detecting composition comprises detecting entry of a next message in the messaging conversation.

13. The method of claim 1, further comprising:
receiving the first input from the client application;
using the first input to generate a first prompt;
sending the first prompt to the LLM;
receiving the response generated by the LLM; and
sending the response to the client application in a plurality of portions.

14. The method of claim 13, wherein the last presented portion corresponds to one of the plurality of portions.

15. The method of claim 14, wherein at least one of the plurality of portions is received by the server application subsequent to the last presented portion.

16. The method of claim 1, wherein the first input and/or the last presented portion of the response is associated with a voice input.

17. The method of claim 16, wherein the voice input is used to generate a text input for the messaging conversation, the text input corresponding to the first input.

18. The method of claim 1, wherein the first input and/or the last presented portion of the response comprises a text input.

19. A computer system comprising:
at least one processor; and
at least one memory, the at least one memory comprising processor executable instructions that, when executed by the at least one processor, cause the computer system to:
receive an indication of an interruption in a messaging conversation at a client application;
determine a last presented portion of a response, the response generated by a large language model (LLM) for the messaging conversation and provided to the client application in response to prompting the LLM with a prompt based on at least a first input provided to the client application; and
modify a chat history maintained by a server application based on the last presented portion of the response.

20. A computer-readable medium comprising processor executable instructions that, when executed by a processor of a computer system, cause the computer system to:
receive an indication of an interruption in a messaging conversation at a client application;
determine a last presented portion of a response, the response generated by a large language model (LLM) for the messaging conversation and provided to the client application in response to prompting the LLM with a prompt based on at least a first input provided to the client application; and
modify a chat history maintained by a server application based on the last presented portion of the response.
